(19) United States
(12) Patent Application Publication
(10) Pub. No.: US 2025/0374876 A1
(43) Pub. Date: Dec. 11, 2025

(54) Intelligent Maintenance Planter

(71) Applicant: Wuxi Coast Redwood loT Technology Development Co.Ltd, Jiangsu (CN)

(72) Inventors: Gaoran SUN, Tianjin (CN); Weikang XIN, Tianjin (CN); Zhe ZHANG, Tianjin (CN)

(73) Assignee: Wuxi Coast Redwood loT Technology Development Co.Ltd, Jiangsu (CN)

(21) Appl. No.: 18/740,366

(22) Filed: Jun. 11, 2024

(51) Int. Cl. A01G 27/00; A01G 27/02

(52) U.S. Cl. CPC A01G 27/003; A01G 27/02

(57) ABSTRACT

An intelligent maintenance planter comprises a planter body, wherein a water bin is arranged in the planter body, and the water bin is fixedly connected with the planter body and forms a second accommodating cavity; a culture bin is arranged in the second accommodating cavity and communicated with the water bin; it further comprises a central system, wherein the central system comprises a control panel, a plurality of sensors and a display screen; the control panel has a monitoring module and an interactive module, the monitoring module is used to receive the information sensed by the sensors and feed the information back to the display screen, and the interactive module is used to process the information sensed by the sensors to form a humanized expression on the display screen.

### TECHNICAL FIELD

The present invention relates to the technical field of potted plants, in particular to an intelligent maintenance planter.

### BACKGROUND

The intelligent planter is provided with a plurality of sensors to monitor the potted situation and feed back the monitored potted state information to the user. However, the existing intelligent planters only transmit the status information of potted plants to users, which cannot directly bring the pleasure of raising potted plants to users and has no concrete feedback experience. For example, the insertable planter, system and methods disclosed in U.S. Patent No. 20230363323 have the above problems, and lack a sense of linkage with users; similarly, the system and method for planting plants and monitoring plant growth disclosed in the US patent with the application number of 20230403992 also have the above problems, which can not increase users' interest in potted plants.

Based on this, it is necessary to put forward a new type of intelligent planter, which can increase users' interest in potted plants and increase the interest in cultivating potted plants while intelligently maintaining a potted plant.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present invention provides an intelligent maintenance planter, which comprises a planter body, wherein the planter body comprises a first accommodating cavity; and
a water bin is arranged in the first accommodating cavity, and the water bin is fixedly connected with the planter body and forms a second accommodating cavity; and
a culture bin is detachably connected in the second accommodating cavity, the culture bin is provided with a third accommodating cavity, and the third accommodating cavity is communicated with the second accommodating cavity; and
the intelligent maintenance planter further comprises a central system, wherein the central system comprises a control panel arranged in the planter body, a plurality of sensors arranged on the planter body, and a display screen arranged on an outer surface of the planter body, wherein the sensors and the display screen are electrically connected with the control panel, and the sensors are used for sensing the information of a plant, the planter body and the surrounding environment; and
the control panel has a monitoring module and an interactive module, wherein the monitoring module is used to receive the information sensed by the sensors and feed the information back to the display screen, and the interactive module is used to process the information sensed by the sensors to form a humanized expression on the display screen.

The present invention further comprises a method for maintaining a potted plant, comprising providing a potted plant and an intelligent maintenance planter, wherein the intelligent maintenance planter comprises a planter body, wherein the planter body comprises a first accommodating cavity; and
a water bin is arranged in the first accommodating cavity, and the water bin is fixedly connected with the planter body and forms a second accommodating cavity; and
a culture bin is detachably connected in the second accommodating cavity, the culture bin is provided with a third accommodating cavity, and the third accommodating cavity is communicated with the second accommodating cavity; and
the intelligent maintenance planter further comprises a central system, wherein the central system comprises a control panel arranged in the planter body, a plurality of sensors arranged on the planter body, and a display screen arranged on an outer surface of the planter body, wherein the sensors and the display screen are electrically connected with the control panel, and the sensors are used for sensing the information of a plant, the planter body and the surrounding environment; and
the control panel has a monitoring module and an interactive module, wherein the monitoring module is used to receive the information sensed by the sensors and feed the information back to the display screen, and the interactive module is used to process the information sensed by the sensors to form a humanized expression on the display screen;
maintenance steps are as follows:
pouring enough water into the water bin;
putting the culture bin into the second accommodating cavity;
then putting the potted plants into the culture bin.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic diagram of an intelligent maintenance planter;

FIG. 2 is a schematic view of FIG. 1;

FIG. 3 is an enlarged schematic view at A in FIG. 2;

FIG. 4 is an exploded view of FIG. 1;

FIG. 5 is a schematic diagram of a culture bin;

FIG. 6 is a schematic view of the upper shell;

FIG. 7 is a schematic view of the inner shell;

FIG. 8 is a schematic view of a water bin, a control panel, and a lower shell;

FIG. 9 is a partial exploded view of FIG. 1.

### IN THE FIGURES

Planter body (1100); First accommodating cavity (1101); Upper shell (1110); First connecting edge (1111); Second fixing hole (1112); Display slot (1113); Sixth fixing hole (1114); Clamping edge (1115); Connecting groove (1116); Clamping groove (1117); Lower shell (1120); Second connecting edge (1121); Fifth fixing hole (1122); Through hole (1123); Inner shell (1130); Platform part (1131); First fixing hole (1132); Abutting groove (1133); Third connecting edge (1134); Fitting groove (1140); First fitting groove (1141); Second fitting groove (1142); Water bin (1200); Second accommodating cavity (1201); First fixing post (1210); First fixing boss (1211); Third fixing hole (1212); Abutting edge (1213); Limiting post (1220); Culture bin (1300); Third accommodating cavity (1301); Supporting post (1310); Limiting part (1320); Limiting hole (1321); Clamping part (1330); Grasping lug (1340); Control panel (1410); Fourth fixing hole (1411); Vibration sensor (1421); Water quantity sensor (1422); Soil humidity sensor (1423); Touch sensor (1424); Temperature sensor (1425); Air humidity sensor (1426); Light sensor (1427); Plant touch sensor (1428); Display screen (1430); Seventh fixing hole (1431).

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

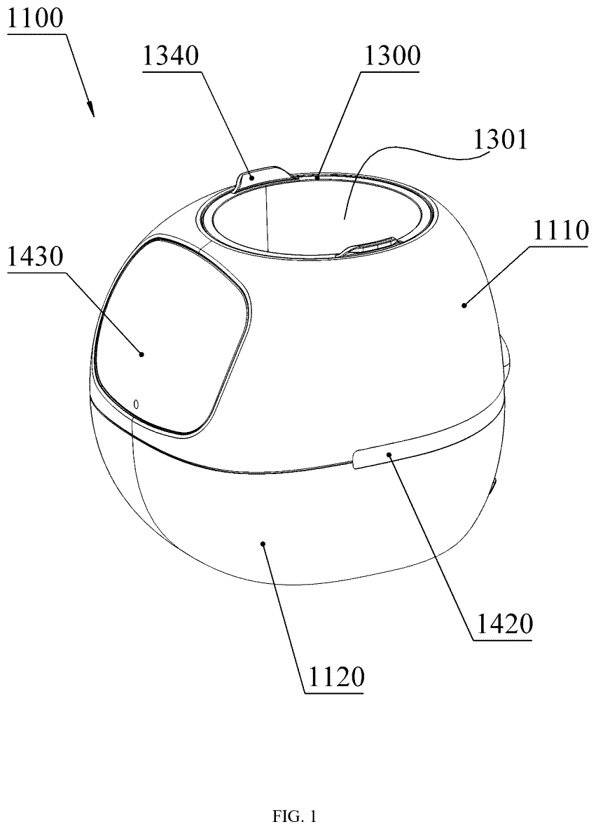

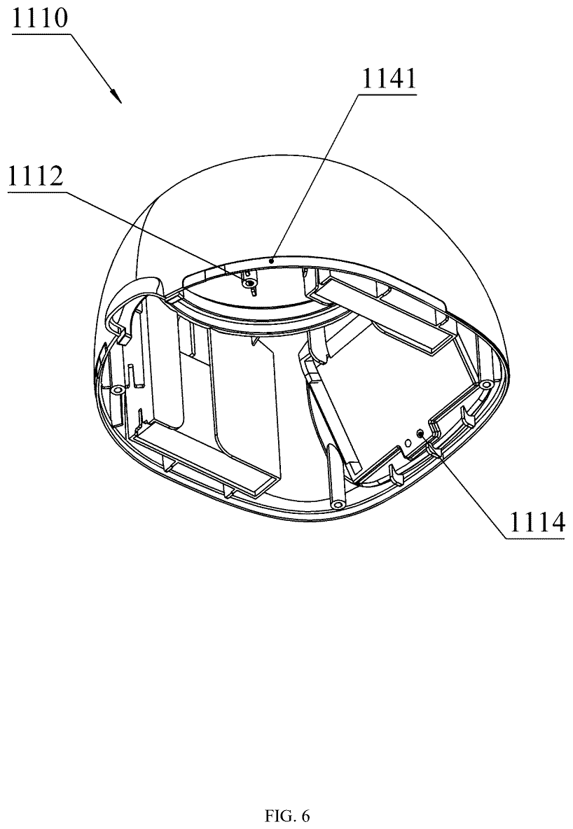

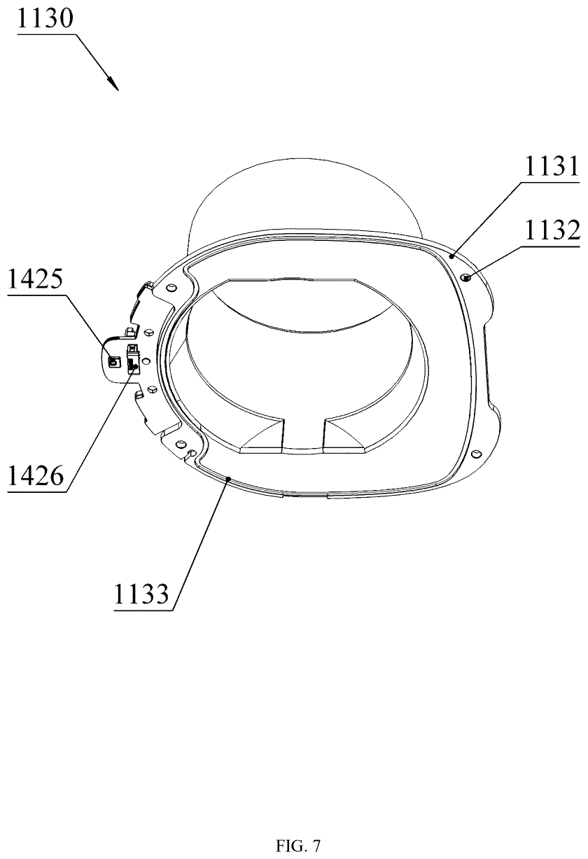

As shown in FIGS. 1 to 9, the present invention provides an intelligent maintenance planter, which comprises a planter body 1100, and the planter body 1100 comprises a first accommodating cavity 1101; a water bin 1200 is arranged in the first accommodating cavity 1101, and the water bin 1200 is fixedly connected with the planter body 1100 and forms a second accommodating cavity 1201; a culture bin 1300 is detachably connected to the second accommodating cavity 1201, the culture bin 1300 has a third accommodating cavity 1301, and the third accommodating cavity 1301 communicates with the second accommodating cavity 1201;
the intelligent maintenance planter further comprises a central system 1400, which comprises a control panel 1410 arranged in the planter body 1100, a plurality of sensors arranged on the planter body 1100, and a display screen 1430 arranged on the outer surface of the planter body 1100, wherein both the sensors and the display screen 1430 are electrically connected with the control panel 1410, and the sensors are used for sensing information of plants, the planter body 1100 and its surrounding environment;
the control panel 1410 has a monitoring module and an interactive module.; the monitoring module is used to receive the information sensed by the sensors and feed the information back to the display screen 1430, and the interactive module is used to process the information sensed by the sensors to form a humanized expression on the display screen 1430.

The intelligent maintenance planter provided by the present invention has the advantages that: through the monitoring and interactive functions of the central system, users can intuitively know the growth status of plants, the internal environment of planters and the surrounding environment information, so that the maintenance strategy can be adjusted more accurately, and the tedious process of frequently manually checking the state of plants is reduced; Sensors can sense the growing environment of plants in real time, such as temperature, humidity, light, etc., and provide users with accurate maintenance suggestions through central system processing, which is helpful for the healthy growth of plants; the culture bin is detachably connected to the water bin, which makes the planter easy to clean and replace components, and also facilitates the user to adjust the culture conditions according to the plant species and growth stages; through the humanized expression on the display screen, the intelligent maintenance planter not only provides feedback on the plant state, but also increases the interactive fun between users and plants, making the maintenance process more interesting; through accurate environmental perception and maintenance suggestions, users can use water resources and nutrients more rationally and reduce unnecessary waste, which conforms to the modern concept of energy conservation and environmental protection.

In some embodiments, an automatic irrigation system is integrated in the intelligent maintenance planter, which automatically supplements water for plants according to the soil humidity and plant demand detected by the sensors, thus realizing intelligent irrigation; according to the growth needs of different plants, the central system can simulate different growth environments, such as temperature, humidity, light, etc., to create more suitable growth conditions for plants; when the sensors detect that plants need fertilization, pruning or soil replacement, the central system can remind users to carry out corresponding maintenance operations through the display screen or mobile phone APP; through the networking function, users can share their maintenance experience and plant growth to the community platform, and interact with other users to jointly improve the maintenance level; the central system can record users' maintenance behavior and plant growth, provide personalized maintenance suggestions through data analysis, and help users learn how to better maintain plants.

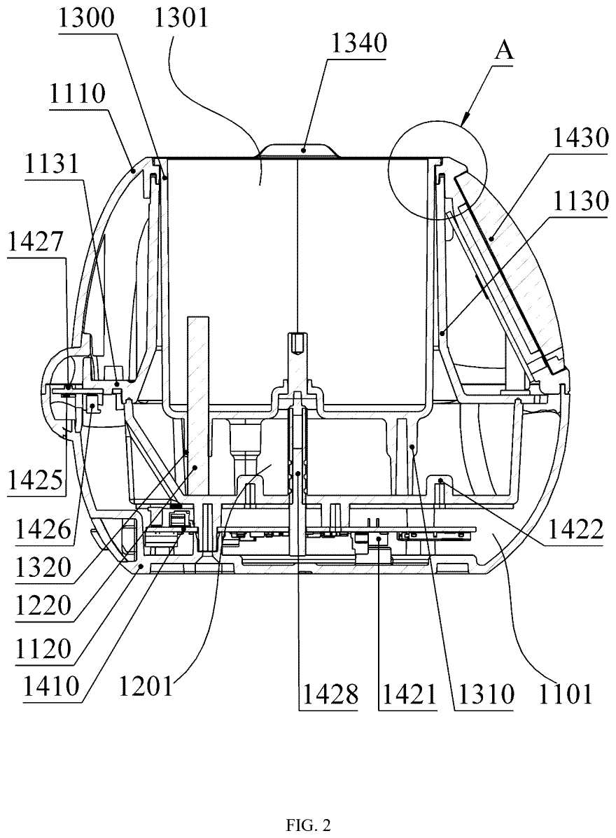

As shown in FIGS. 2 to 4, in this embodiment, the planter body 1100 includes an upper shell 1110 and a lower shell 1120. A first connecting edge 1111 is formed at one end of the upper shell 1110 close to the lower shell 1120, and a second connecting edge 1121 is formed on the lower shell 1120. The second connecting edge 1121 is arranged in a shape corresponding to the first connecting edge 1111. The upper shell 1110 is fixedly connected with the lower shell 1120, wherein the upper shell 1110 and the lower shell 1120 are cooperatively connected through the first connecting edge 1111 and the second connecting edge 1121.

In this embodiment, the upper shell is designed to be wider, which is mainly used to contain soil and plants, while ensuring enough space for the growth of plant roots. A first connecting edge is extended and formed at one end of the upper shell close to the lower shell, and this connecting edge is designed to be flat and has a certain strength to ensure a stable connection with the lower shell. The lower shell is relatively small, which is mainly used to accommodate electronic equipment such as the central system, sensors and display screens, as well as water warehouses and culture warehouses. A second connecting edge is extended and formed on the lower shell, and the shape of the second connecting edge is completely corresponding to that of the first connecting edge, so as to ensure that the two can be closely matched.

In this embodiment, when assembling, the first connecting edge of the upper shell is aligned with the second connecting edge of the lower shell, and then they are fixedly connected together by gluing, welding or other fixing methods. This design makes the connection between the upper shell and the lower shell stable and easy to disassemble, which is convenient for users to clean, repair or replace parts.

Through the cooperation of the first connecting edge and the second connecting edge, the upper shell and the lower shell can form a tight and fixed connection, thus ensuring that the whole planter structure is stable and not easy to loosen or deform. Because the upper shell and the lower shell are detachably connected, users can easily disassemble the planter, which is convenient for internal cleaning, maintenance or replacement of parts;, so that it is easier to replace culture bins with different sizes or shapes; through carefully designed connecting edges and fixing methods, the joint between the upper shell and the lower shell can be smooth and seamless, which is both beautiful and practical, and will not affect the growth of plants and the viewing experience of users; the design of the whole intelligent maintenance planter is more flexible and extensible, and more functional modules can be added or existing modules can be improved as needed in the future, without large-scale changes to the whole planter.

In other embodiments (not shown in the figure), the upper shell and the lower shell are not limited to the above-mentioned fixed connection, but can also be fixed by screw connection, pin connection, rivet connection, snap connection and any desired connection mode.

As shown in FIGS. 1 to 7, in this embodiment, the upper shell 1110 is provided with an inner shell 1130, which is fixedly connected with the upper shell 1110. The inner shell 1130 includes a platform part 1131, and the platform part 1131 is provided with a first fixing hole 1132, and the upper shell 1110 is provided with a second fixing hole 1112, which corresponds to the first fixing hole 1132, wherein the upper shell 1110 and the inner shell 1130 are fixedly connected by a first fixing member.

In this embodiment, an inner shell is arranged in the upper shell of the intelligent maintenance planter, which is fixedly connected with the upper shell to form a complete upper structure. The inner shell mainly comprises a platform part, and a plurality of first fixing holes are arranged at specific positions of the platform part, and these fixing holes are used for subsequent fixing and connecting operations. Corresponding to the first fixing holes of the inner shell, the upper shell is further comprised with a plurality of second fixing holes. The positions and numbers of these second fixing holes are completely matched with the first fixing holes to ensure that the upper shell and the inner shell can be firmly connected together.

In the assembly process, firstly, the platform part of the inner shell is placed at the corresponding position of the upper shell, so that the first fixing hole is aligned with the second fixing hole. Then, the inner shell and the upper shell are fixedly connected together by a first fixing member (such as screws, rivets, etc.). This connection mode is simple and firm, which can ensure the stability and position accuracy of the inner shell in the upper shell.

In other embodiments (not shown in the figure), the upper shell and the inner shell are not limited to the above-mentioned fixed connection, but can also be set to be welded, snap-in connection and any desired connection mode to form a fixed connection.

As shown in FIGS. 2 to 8, in this embodiment, a water bin 1200 and a control panel 1410 are arranged in a lower shell 1120, at least one first fixing post 1210 is formed on the lower bottom surface of the water bin 1200; a first fixing boss 1211 is formed on the periphery of the fixing post, and a third fixing hole 1212 is formed on the first fixing post 1210; a fourth fixing hole 1411 is formed on the control panel 1410, and the fourth fixing hole 1411 corresponds to the first fixing post 1210; the lower shell 1120 is provided with a fifth fixing hole 1122 corresponding to the third fixing hole 1212; and
wherein the lower shell 1120, the water bin 1200 and the control panel 1410 are fixedly connected through the second fixing member, and the control panel 1410 abuts against the first fixing boss 1211.

In this embodiment, a water bin and a control panel are arranged in the lower shell. The lower bottom surface of the water bin is provided with at least one first fixing post, and a first fixing boss is formed on the periphery of the fixing post. Each fixing post is provided with a third fixing hole, and the control panel is provided with a fourth fixing hole corresponding to the third fixing hole. Meanwhile, the lower shell is further provided with a fifth fixing hole corresponding to the third fixing hole. When assembling, the lower shell, the water bin and the control panel are firmly connected by allowing the second fixing members to pass through the corresponding fixing holes, and the control panel is closely attached to the first fixing boss.

In other embodiments (not shown in the figure), the lower shell, the water bin and the control panel are not limited to being fixedly connected by the above-mentioned methods, but can also be arranged to be welded, buckled and connected in any desired way.

Through the cooperative use of the fixing post, the fixing hole and the fixed member, the stable connection of the lower shell, the water bin and the control panel is realized, and the stability of the whole structure is enhanced. This design simplifies the installation steps, and users can easily complete the assembly without complicated operations, which improves the convenience of use. The design of the first fixed boss ensures the smoothness of the installation of the control panel and improves the operation experience. This structure makes each component have certain independence, which is convenient for individual replacement or upgrade, and increases the flexibility of design.

In this embodiment, the water bin of the intelligent maintenance planter not only has the water storage function, but also integrates the intelligent irrigation system. A water level sensor and a water pump are arranged in the water bin, and the water level sensor detects the water level in the water bin in real time and transmits the data to the control panel. When the water level is lower than the set value, the control panel will automatically start the water pump to pump water from the water warehouse to the roots of plants to realize automatic irrigation.

In addition, the control panel also has the function of regular irrigation, and users can set the irrigation time and amount according to the growth demand of plants. This integrated design not only simplifies the user's operation, but also ensures that plants get timely and appropriate water, and improves the maintenance effect.

The control panel in this embodiment not only has the function of controlling the intelligent irrigation system, but also integrates the environmental monitoring module and the data analysis module. The environmental monitoring module includes a temperature and humidity sensor and a light sensor, which can detect the environmental parameters in the planter in real time. The data analysis module is responsible for processing these sensor data and providing maintenance suggestions according to the preset maintenance strategy.

Users can view the current environmental parameters and maintenance suggestions through the control panel, and can also set and adjust maintenance strategies. In addition, the control panel also supports the connection with devices such as smart phones, and users can remotely monitor and control the running status of planters through the mobile APP.

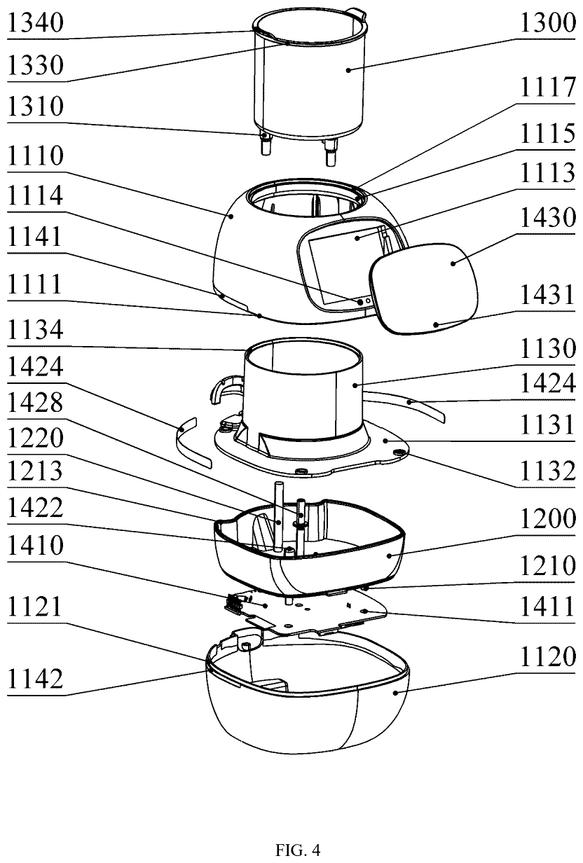

As shown in FIGS. 4 to 6, in this embodiment, the upper shell 1110 is provided with a display slot 1113, a display screen 1430 is arranged in the display slot 1113, a sixth fixing hole 1114 is formed in the display slot 1113, and a seventh fixing hole 1431 is provided on the display screen 1430, the seventh fixing hole 1431 corresponds to the sixth fixing hole 1114, wherein the display screen 1430 and the upper shell 1110 are fixedly connected through the third fixing member.

In this embodiment, the upper shell of the intelligent maintenance planter is designed with a special display slot for installing the display screen. The size and shape of the display slot are matched with the display screen, which ensures that the display screen can be stably placed in the slot. At an appropriate position of the display slot, a sixth fixing hole is formed so as to correspond to the seventh fixing hole on the display screen. In the installation process, the display screen is placed in the display slot, and the seventh fixing hole is precisely aligned with the sixth fixing hole. Then, the third fixing member (such as screw or buckle) passes through the corresponding fixing hole to firmly connect the display screen with the upper shell.

In other embodiments (not shown in the figure), the upper shell and the display screen are not limited to the above-mentioned fixed connection, but can also be set to be welded, snap-in connection and any desired connection mode to form a fixed connection.

In this embodiment, the display screen adopts a high-definition liquid crystal panel, which has a higher resolution and a wider viewing angle, so that users can clearly view information such as plant growth data and environmental parameters. At the same time, the display screen also supports touch operation, and users can set parameters and switch modes by touching the screen, which improves the convenience of interaction. In addition, users can also project pictures they want to see or play videos they want to see on the display screen through mobile APP, Bluetooth and other means.

As shown in FIGS. 4 to 8, in this embodiment, an abutting edge 1213 is formed at the upper end of the water bin 1200, and an abutting groove 1133 is formed at one end of the inner shell 1130 near the water bin 1200. Wherein, the water bin 1200 and the inner shell 1130 form abutment by the abutting edge 1213 and the abutting groove 1133. In some embodiments, a sealing ring is disposed in the abutting groove.

In this embodiment, the connection mode between the water bin and the inner shell of the intelligent maintenance planter is optimized. The upper end of the water bin is designed with a specific abutting edge, which is annular and closely connected with the upper end edge of the water bin to form a smooth and stable connection surface. The surface of the abutting edge is carefully treated to ensure that its contact surface with the inner shell is flat and smooth, so as to reduce friction and wear. One end of the inner shell near the water bin is provided with a corresponding abutting groove. The shape and size of the abutting groove are matched with the abutting edge of the water bin, so that the two can be accurately butted. The interior of the abutting groove is also specially treated to provide a smooth surface matching the abutting edge.

In the assembly process, the abutting edge of the water bin is precisely inserted into the abutting groove of the inner shell, and the two are closely abutted together. This design not only ensures the stable and reliable connection between the water bin and the inner shell, but also simplifies the installation steps and improves the production efficiency.

In other embodiments (not shown in the figure), the water bin and the inner shell are not limited to the above-mentioned fixed connection, but can also be set to be welded, snap-in connection and any desired connection mode to form a fixed connection.

Through the close cooperation between the abutting edge and the abutting groove, the connection between the water bin and the inner shell becomes more stable, which can effectively prevent the parts from loosening or separating due to vibration or external force, thus improving the stability of the whole planter structure; the design of the abutting edge and the abutting groove simplifies the installation process of the water bin and the inner shell, and users can easily complete the docking of the two without using additional fixing members or tools, which not only improves the convenience of installation, but also reduces the risk of installation errors caused by improper operation. The close matching between the abutting edge and the abutting groove also enhances the sealing performance of the water bin, which effectively reduces the gap between the water bin and the inner shell, prevents water from leaking and avoids wetting other parts inside the planter; the connection between the water bin and the inner shell is simple and stable, and users can conveniently disassemble and assemble the two parts when cleaning or repairing the planter, thus improving the convenience of maintenance and reducing the maintenance cost.

As shown in FIGS. 1 to 5, in this embodiment, a culture bin 1300 is arranged in the inner shell 1130 and the water bin 1200, at least one supporting post 1310 and a limiting part 1320 are formed at the bottom of the culture bin 1300; a limiting hole 1321 is arranged in the limiting part 1320, the supporting post 1310 abuts against the water bin 1200, and the limiting post 1220 is arranged on the water bin 1200; the limiting post 1220 matches the limiting hole 1321, and he culture bin 1300 is detachably connected in the inner shell 1130 and the water bin 1200 through the supporting post 1310, the limiting part 1320 and the limiting post 1220.

In this embodiment, the structural design of the intelligent maintenance planter has been further optimized, especially the part of the culture bin arranged in the inner shell and the water bin. As the core area of plant growth, the stability and ease of use of culture bin are very important for the performance of the whole planter.

Specifically, the bottom of the culture bin is designed with at least one supporting post and a limiting part. The supporting post is made of durable materials and has enough bearing capacity to ensure the stable placement of the culture bin. The bottom of the supporting post is closely abutted against the inner surface of the water bin, thus preventing the culture bin from shaking or tilting in the water bin. The limiting part is located next to the supporting post, and a limiting hole is arranged in it. The shape and size of the limiting hole are carefully designed to ensure the accurate matching with the limiting post to be described. This design not only improves the stability of the structure, but also facilitates the disassembly and installation of the culture bin. At the same time, a limiting post is arranged at the corresponding position of the water bin. The shape of the limiting post is matched with the limiting hole, so that the limiting post can be accurately inserted into the limiting hole when the culture bin is placed. This connection mode is simple and firm, which effectively prevents the culture bin from shifting or falling off in the water bin.

In this way, the culture bin is detachably connected in the inner shell and the water bin through the cooperative action of the supporting post, the limiting part and the limiting post. This design not only improves the stability of the culture bin, but also enables users to disassemble and install it easily when they need to clean or replace the culture bin.

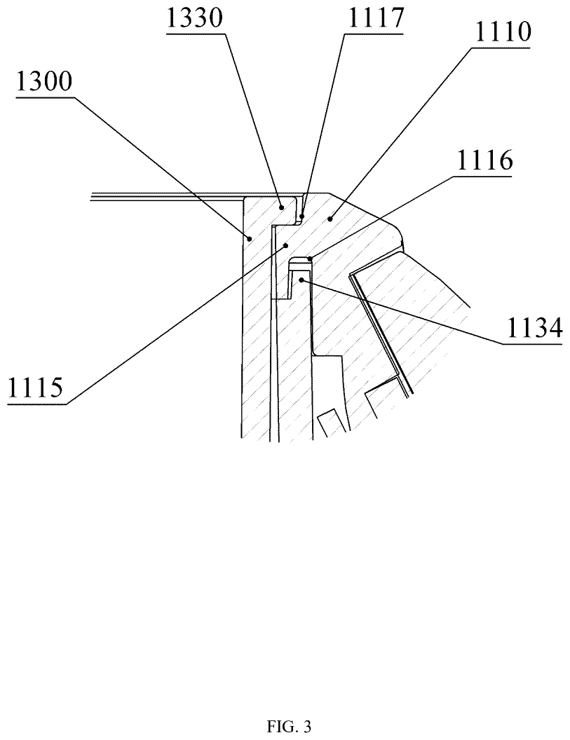

As shown in FIGS. 2 to 3, in this embodiment, the upper shell 1110 is provided with a clamping edge 1115, and an end of the clamping edge 1115 facing the inner shell 1130 is formed with a connecting groove 1116, and an end of the inner shell 1130 far away from the water bin 1200 is provided with a third connecting edge 1134, the third connecting edge 1134 is set in a shape corresponding to the connecting groove 1116, wherein the third connecting edge 1134 is arranged in the connecting groove 1116 when the upper shell 1110 and the inner shell 1130 are fixedly connected.

In this embodiment, a clamping groove 1117 is formed at one end of the clamping edge 1115 far from the inner shell 1130, a clamping part 1330 is arranged at the upper end of the culture bin 1300, and the clamping part 1330 is set in a shape corresponding to the clamping groove 1117, wherein the clamping part 1330 is arranged in the clamping groove 1117 when the culture bin 1300 is arranged in the second accommodating cavity 1201.

In this embodiment, the connection structure between the upper shell and the inner shell of the intelligent maintenance planter has been further optimized, and the fixing method between the culture bin and the upper shell has also been innovatively designed.

First of all, the upper shell is designed with a clamping edge, which not only enhances the structural strength of the upper shell, but further comprises convenience for its connection with the inner shell. A connecting groove is formed at one end of the clamping edge facing the inner shell, and this connecting groove has an accurate size and shape to ensure a close fit with the third connecting edge of the inner shell.

The inner shell is provided with a third connecting edge at one end far away from the water bin, and the shape of the third connecting edge is matched with the connecting groove. In the assembly process, the third connecting edge is accurately inserted into the connecting groove, thus realizing the fixed connection between the upper shell and the inner shell. This connection mode is not only firm and reliable, but also easy to operate, which greatly improves the production efficiency.

In addition, this embodiment also improves the connection mode between the culture bin and the upper shell. Specifically, a clamping groove is formed at the end of the clamping edge far from the inner shell, which makes the culture bin more firmly fixed on the upper shell. The upper end of the culture bin is provided with a clamping part, and the shape of the clamping part is matched with the clamping groove. When the culture bin is placed in the second accommodating cavity, the clamping part will naturally clamp into the clamping groove, thus realizing the fixed connection between the culture bin and the upper shell.

In other embodiments (not shown in the figure), the culture bin and the upper shell are not limited to the above-mentioned fixed connection, but can also be set to be welded, snap-in connection and any desired connection mode to form a fixed connection.

By optimizing the connection structure between the upper shell and the inner shell, and adopting the close cooperation between the clamping edge and the third connecting edge, the whole planter structure is more stable. This design effectively prevents the parts from loosening or falling off due to vibration or external force, and improves the durability and service life of the planter. The design of the clamping edge and the third connecting edge makes the installation and disassembly of the upper shell and the inner shell simple and quick. Users can easily assemble and disassemble components without using additional tools or complicated operations. This not only improves the production efficiency, but also reduces the risk of damage caused by improper operation. The upper shell, the inner shell, the culture bin and other components are all designed in a modular way, which makes the components have certain independence. This design is not only convenient to replace or upgrade the components separately, but also improves the flexibility and customization of the whole planter.

As shown in FIGS. 1 to 5, in this embodiment, a grasping lug 1340 is provided at the upper end of the culture bin 1300.

Specifically, the grasping lug is skillfully arranged at the upper end of the culture bin, and its shape and size are designed to ensure that users can grasp it conveniently when they need to move or operate the culture bin. Grasping lugs are usually made of soft and elastic materials to ensure the comfort and stability of grasping. At the same time, the color and texture of the grasping lugs are also selected to coordinate with the design style of the whole planter and enhance the overall aesthetics. The design of the grasping lugs makes it easy for users to grasp when they need to move or operate the culture bin, and it is not necessary to find a suitable grasping point. This greatly simplifies the operation steps and improves the operation efficiency.

As shown in FIGS. 2 to 8, in this embodiment, the intelligent maintenance planter integrates various sensors to realize all-round plant maintenance monitoring and intelligent management. These sensors include a vibration sensor 1421, a water quantity sensor 1422, a soil humidity sensor 1423, a touch sensor 1424, a temperature sensor 1425, an air humidity sensor 1426 and a light sensor 1427, which play different roles and jointly construct an intelligent sensing system.

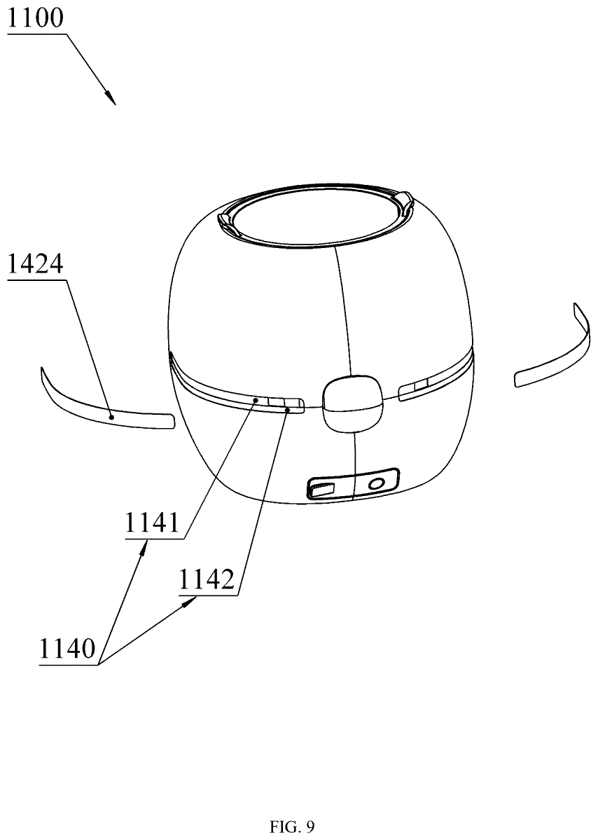

As shown in FIG. 9, in this embodiment, the outer surface of the planter body 1100 is provided with at least one fitting groove 1140, and the fitting groove 1140 is arranged in a shape corresponding to the touch sensor 1424. When the touch sensor 1424 is arranged in the fitting groove 1140, the outer surface of the planter body 1100 is flat. In this embodiment, the touch sensor 1424 is disposed at the joint of the upper shell 1110 and the lower shell 1120. The fitting groove 1140 includes a first fitting groove 1141 and a second fitting groove 1142, which are combined to form the fitting groove 1140. The first fitting groove 1141 is disposed on the upper shell 1110 and the second fitting groove 1142 is disposed on the lower shell 1120.

The touch sensor is embedded in the outer surface of the planter body, and a flat appearance is realized through the attached groove. This design not only improves the overall aesthetics of the planter, but also enables users to interact with the planter conveniently.

Through the touch sensor, users can easily operate various functions of the planter, such as adjusting illumination and temperature, and realize an intelligent plant maintenance experience.

The vibration sensor is arranged at the bottom of the control panel. This design is not only convenient to sense the external vibration of the planter, but also can ensure the sensitivity and accuracy of the sensor to vibration through the through hole arranged on the lower shell. The arrangement of the through hole enables the sensor to better contact with the external environment, so as to respond to any movement or external vibration of the planter in time and provide real-time feedback on the state of the planter for users.

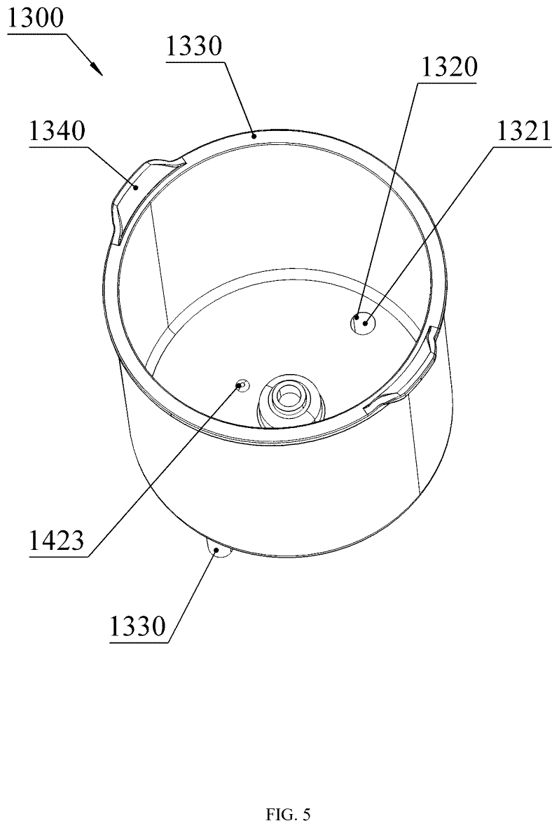

As shown in FIG. 5, in this embodiment, a soil humidity sensor 1423 is provided in the culture bin 1300. The soil humidity sensor is placed in the culture bin and directly contacts the soil. This design enables the sensor to sense the change of soil moisture in real time and provide users with accurate soil moisture data. Through the soil humidity sensor, users can know the growing environment of plants in time and make appropriate adjustments as needed to ensure the healthy growth of plants.

As shown in FIG. 2, in this embodiment, a light sensor 1427 is arranged above the platform part 1131, and a temperature sensor 1425 and an air humidity sensor 1426 are arranged below the platform part 1131, wherein the space where plants grow is misaligned with the detection space of the light sensor, and when plants receive illumination, the light sensor synchronously receives illumination. Specifically, there is a certain distance and angle between the light sensor and the plant, so as to ensure that when the plant grows, it will not block the light to the light sensor, making the measurement data of the light sensor inaccurate.

The light sensor is placed above the platform, and is specially used to monitor the illumination intensity and illumination time. Through the light sensor, users can know the lighting conditions needed by plants, and adjust the lighting equipment according to the actual situation to provide the best growth environment for plants. The temperature sensor and the air humidity sensor are respectively arranged above and below the platform part to comprehensively monitor the temperature and humidity changes around the planter. This design enables the sensor to reflect the environmental conditions of plant growth more accurately and provide users with more accurate maintenance suggestions.

As shown in FIGS. 2 to 4, in this embodiment, a water quantity sensor 1422 is provided in the water bin 1200. The water quantity sensor is configured in the water bin and is specially used to monitor the change of water quantity in the water bin. This design enables users to know the water storage situation of the water warehouse at any time and ensure that plants get sufficient water supply. At the same time, the accurate measurement of water sensor further comprises reliable data support for intelligent irrigation system and realizes automatic watering management.

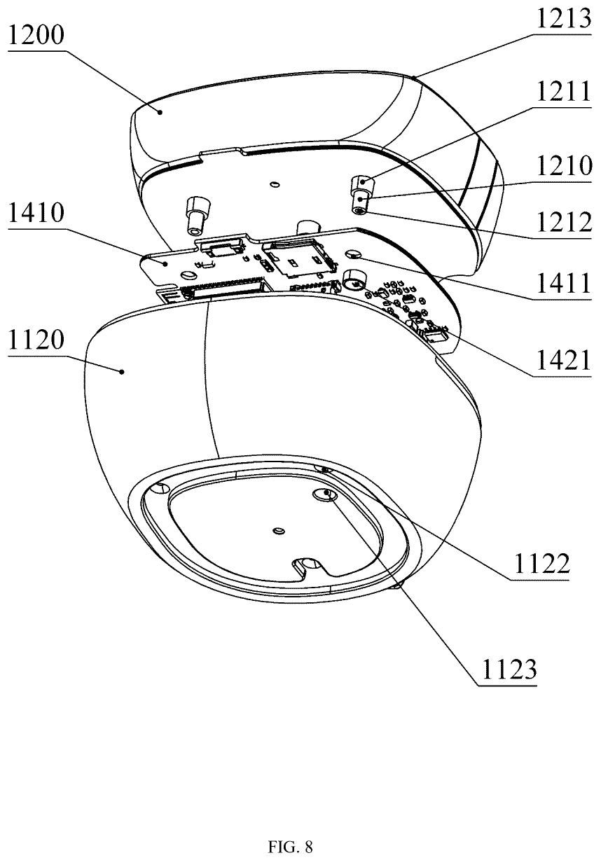

As shown in FIG. 8, in this embodiment, a vibration sensor 1421 is provided at the bottom of the control panel 1410, and a through hole 1123 is provided on the lower shell 1120, and the through hole 1123 is provided at a position corresponding to the vibration sensor 1421.

As shown in FIGS. 2 to 4, in this embodiment, a plant touch sensor 1428 is inserted in the water bin 1200 and the culture bin 1300, one end of the plant touch sensor 1428 is positioned in the culture bin 1300, and the other end of the plant touch sensor 1428 is electrically connected with the control panel 1410.

Among them, the plant touch sensor circuit sends out an electrical signal, and the electrical signal passes through the metal needle in the plant touch sensor, the plant cavity matrix and the plant body to form a detection circuit. When the human body or other external objects touch the plant, the parameters such as the capacitance of the circuit will change, and the sensor monitoring circuit judges whether the plant is touched by detecting these changes.

In this embodiment, the plant touch sensor is used to sense the information that plants contact with the outside world, and the control panel has a monitoring module and an interactive module. The monitoring module is used to receive the information sensed by the plant touch sensor and feed the information back to the display screen, and the interactive module is used to process the information sensed by the plant touch sensor to form a humanized expression on the display screen.
the present invention further comprises a potted plant maintenance method, which comprises the following steps: providing a potted plant and an intelligent maintenance planter, wherein the intelligent maintenance planter comprises a planter body, and the planter body comprises a first accommodating cavity; a water bin is arranged in the first accommodating cavity, and the water bin is fixedly connected with the planter body and forms a second accommodating cavity; a culture bin is detachably connected in the second accommodating cavity, and the culture bin is provided with a third accommodating cavity, and the third accommodating cavity is communicated with the second accommodating cavity; and
the intelligent maintenance planter further comprises a central system, wherein the central system comprises a control panel arranged in the planter body, a plurality of sensors arranged on the planter body, and a display screen arranged on the outer surface of the planter body, wherein the sensors and the display screen are electrically connected with the control panel, and the sensors are used for sensing the information of plants, the planter body and the surrounding environment; and
the control panel is provided with a monitoring module and an interactive module, wherein the monitoring module is used for receiving the information sensed by the sensors and feeding the information back to the display screen, and the interactive module is used for processing the information sensed by the sensors to form a humanized expression on the display screen;
the maintenance steps are as follows:
pouring enough water into the water bin;
putting the culture bin into the second accommodating cavity;
then putting the potted plants into the culture bin.

Specifically, the sensors include a vibration sensor, a water quantity sensor, a soil humidity sensor, a touch sensor, a temperature sensor, an air humidity sensor, and a light sensor.

Specifically, when the monitoring module receives the signals of water shortage of potted plants from the water quantity sensor and the soil humidity sensor, the detection module transmits the information of water shortage to the display screen, and the interactive module generates thirsty expressions from the signals of water shortage of potted plants and transmits them to the display screen; and
when users add water to the water bin and the culture bin, the monitoring module receives the signals that the potted plants have been replenished with water from the water quantity sensor and the soil humidity sensor, the detection module transmits the information of sufficient water quantity to the display screen, and the interactive module generates an expression of drinking water from the signal of sufficient water quantity and transmits it to the display screen.

Specifically, when the monitoring module receives the signal that the potted plants lack illumination from the light sensor, the detection module transmits the lack of illumination to the display screen, and the interactive module generates an hungry expression from the lack of illumination signal and transmits it to the display screen; and
when the user illuminates the potted plant, the monitoring module receives the signal that the potted plant is receiving illumination from the light sensor, the detection module transmits the information of receiving illumination to the display screen, and the interactive module generates an expression of eating from the signal of receiving illumination and transmits it to the display screen.

Specifically, when the monitoring module receives the signal that the potted plant is touched from the touch sensor, the interactive module will generate a happy expression from the touch signal of the potted plant and transmit it to the display screen.

The intelligent maintenance planter provided by the present invention has many use scenarios, including but not limited to the following scenarios: in the family environment, the intelligent maintenance planter can be used as a part of home decoration, bringing a green and ecological atmosphere to the family; in offices, conference rooms and other office places, intelligent maintenance of planters can be used as a part of indoor greening to create a comfortable and pleasant working environment for employees; in shopping malls, exhibition halls and other commercial exhibition places, intelligent maintenance planters can be used as the main tool to display plants; in educational institutions, plant lovers clubs and other places, intelligent maintenance planters can be used as teaching or training tools.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. An intelligent maintenance planter, comprising:
a planter body, wherein the planter body comprises a first accommodating cavity; and
a water bin is arranged in the first accommodating cavity, and the water bin is fixedly connected with the planter body and forms a second accommodating cavity; and
a culture bin is detachably connected in the second accommodating cavity, the culture bin is provided with a third accommodating cavity, and the third accommodating cavity is communicated with the second accommodating cavity; and
the intelligent maintenance planter further comprises a central system, wherein the central system comprises a control panel arranged in the planter body, a plurality of sensors arranged on the planter body, and a display screen arranged on an outer surface of the planter body, wherein the sensors and the display screen are electrically connected with the control panel, and the sensors are used for sensing the information of a plant, the planter body and the surrounding environment; and
the control panel has a monitoring module and an interactive module, wherein the monitoring module is used to receive the information sensed by the sensors and feed the information back to the display screen, and the interactive module is used to process the information sensed by the sensors to form a humanized expression on the display screen.

2. The intelligent maintenance planter according to claim 1, wherein the planter body comprises an upper shell and a lower shell, a first connecting edge is formed on one end of the upper shell close to the lower shell, and a second connecting edge is formed on the lower shell, the second connecting edge being arranged in a shape corresponding to the first connecting edge; and
the upper shell and the lower shell are fixedly connected, wherein the upper shell and the lower shell are matched to form a fixed connection through the first connecting edge and the second connecting edge.

3. The intelligent maintenance planter according to claim 2, wherein an inner shell is arranged in the upper shell, and the inner shell is fixedly connected with the upper shell; and
the inner shell comprises a platform part, wherein the platform part is provided with a first fixing hole, and the upper shell is provided with a second fixing hole corresponding to the first fixing hole, wherein the upper shell and the inner shell are fixedly connected through a first fixing member.

4. The intelligent maintenance planter according to claim 3, wherein the water bin and the control panel are arranged in the lower shell, at least one first fixing post is formed on a lower bottom surface of the water bin, and a first fixing boss is formed on a periphery of the fixing post; a third fixing hole is formed on the first fixing post, a fourth fixing hole is arranged on the control panel, and the fourth fixing hole corresponds to the first fixing post; a fifth fixing hole is arranged on the lower shell, and the fifth fixing hole corresponds to the third fixing hole; and
wherein, the lower shell, the water bin and the control panel are fixedly connected through a second fixing member, and the control panel abuts against the first fixing boss.

5. The intelligent maintenance planter according to claim 4, wherein a display slot is arranged on the upper shell, the display screen is arranged in the display slot; and
a sixth fixing hole is formed in the display slot, a seventh fixing hole is arranged on the display screen, and the seventh fixing hole corresponds to the sixth fixing hole, wherein the display screen and the upper shell are fixedly connected through a third fixing member.

6. The intelligent maintenance planter according to claim 5, wherein an abutting edge is formed at an upper end of the water bin, and an abutting groove is formed at one end of the inner shell close to the water bin; and
wherein, the water bin and the inner shell form abutment by abutting edges and abutting grooves.

7. The intelligent maintenance planter according to claim 6, wherein the culture bin is arranged in the inner shell and the water bin, at least one supporting post and a limiting part are formed at the bottom of the culture bin, and a limiting hole is arranged in the limiting part; and
the supporting post abuts against the water bin, a limiting post is arranged on the water bin, and the limiting post is matched with the limiting hole, wherein the culture bin is detachably connected in the inner shell and the water bin through the supporting post, the limiting part and the limiting post.

8. The intelligent maintenance planter according to claim 7, wherein the upper shell is provided with a clamping edge, one end of the clamping edge facing the inner shell is provided with a connecting groove, and one end of the inner shell far away from the water bin is provided with a third connecting edge, which is set in a shape corresponding to the connecting groove, wherein when the upper shell and the inner shell are fixedly connected, the third connecting edge is arranged in the connecting groove.

9. The intelligent maintenance planter according to claim 8, wherein a clamping groove is formed at one end of the clamping edge away from the inner shell, and a clamping part is arranged at the upper end of the culture bin, and the clamping part is arranged in a shape corresponding to the clamping groove, wherein when the culture bin is arranged in the second accommodating cavity, the clamping part is arranged in the clamping groove.

10. The intelligent maintenance planter according to claim 3, wherein the sensors comprise a vibration sensor, a water quantity sensor, a soil humidity sensor, a touch sensor, a temperature sensor, an air humidity sensor, a light sensor, and a plant touch sensor.

11. The intelligent maintenance planter according to claim 10, wherein at least one fitting groove is arranged on an outer surface of the planter body, and the fitting groove is arranged in a shape corresponding to the touch sensor, and when the touch sensor is arranged in the fitting groove, the outer surface of the planter body is flat.

12. The intelligent maintenance planter according to claim 11, wherein the soil humidity sensor is arranged in the culture bin.

13. The intelligent maintenance planter according to claim 12, wherein the light sensor is arranged above the platform part, and the temperature sensor and the air humidity sensor are arranged below the platform part; and
wherein the space where the plant grows is misaligned with a detection space of the light sensor, and when the plant receives light, the light sensor receives light synchronously.

14. The intelligent maintenance planter according to claim 13, wherein the water quantity sensor is arranged in the water bin.

15. The intelligent maintenance planter according to claim 14, wherein the vibration sensor is arranged at the bottom of the control panel, and a through hole is arranged on the lower shell, and the through hole is arranged at a position corresponding to the vibration sensor.

16. The intelligent maintenance planter according to claim 15, wherein the plant touch sensor penetrates through the water bin and the culture bin, one end of the plant touch sensor is positioned in the culture bin, and the other end of the plant touch sensor is electrically connected with the control panel.

17. A method for maintaining a potted plant, comprising providing a potted plant and an intelligent maintenance planter, wherein the intelligent maintenance planter comprises a planter body, wherein the planter body comprises a first accommodating cavity; and
a water bin is arranged in the first accommodating cavity, and the water bin is fixedly connected with the planter body and forms a second accommodating cavity; and
a culture bin is detachably connected in the second accommodating cavity, the culture bin is provided with a third accommodating cavity, and the third accommodating cavity is communicated with the second accommodating cavity; and
the intelligent maintenance planter further comprises a central system, wherein the central system comprises a control panel arranged in the planter body, a plurality of sensors arranged on the planter body, and a display screen arranged on an outer surface of the planter body, wherein the sensors and the display screen are electrically connected with the control panel, and the sensors are used for sensing the information of a plant, the planter body and the surrounding environment; and
the control panel has a monitoring module and an interactive module, wherein the monitoring module is used to receive the information sensed by the sensors and feed the information back to the display screen, and the interactive module is used to process the information sensed by the sensors to form a humanized expression on the display screen; and
maintenance steps are as follows:
pouring enough water into the water bin; and
putting the culture bin into the second accommodating cavity; and
then putting the potted plants into the culture bin.

18. The method for maintaining a potted plant according to claim 17, wherein the sensors comprise a vibration sensor, a water quantity sensor, a soil humidity sensor, a touch sensor, a temperature sensor, an air humidity sensor, and a light sensor.

19. The method for maintaining a potted plant according to claim 18, wherein when the monitoring module receives a signal of water shortage of the potted plant from the water quantity sensor and the soil humidity sensor, a detection module transmits the information of water shortage to the display screen, and the interactive module generates a thirsty expression from the signal of water shortage of the potted plant and transmits the thirsty expression to the display screen; and
wherein when a user adds water to the water bin and the culture bin, the monitoring module receives the signal that the potted plant has been replenished with water from the water quantity sensor and the soil humidity sensor, the detection module transmits the information of sufficient water quantity to the display screen, and the interactive module generates an expression of drinking water from the signal of sufficient water quantity and transmits the expression of drinking water to the display screen.

20. An intelligent maintenance planter, comprising:
a planter body, wherein planter body comprises a first accommodating cavity; and
a water bin is arranged in the first accommodating cavity, and the water bin is fixedly connected with the planter body and forms a second accommodating cavity; and
a culture bin is detachably connected in the second accommodating cavity, the culture bin is provided with a third accommodating cavity, and the third accommodating cavity is communicated with the second accommodating cavity; and
the intelligent maintenance planter further comprises a central system, wherein the central system comprises a control panel arranged in the planter body, a plurality of sensors arranged on the planter body, and a display screen arranged on an outer surface of the planter body, wherein the sensors and the display screen are electrically connected with the control panel, and the sensors comprise a plant touch sensor, and the plant touch sensor is used for sensing the information that plant contacts with the outside; and
the control panel has a monitoring module and an interactive module, wherein the monitoring module is used to receive the information sensed by the plant touch sensor and feed the information back to the display screen, and the interactive module is used to process the information sensed by the plant touch sensor to form a humanized expression on the display screen.
